(19) United States
(12) Patent Application Publication
(10) Pub. No.: US 2022/0112723 A1
(43) Pub. Date: Apr. 14, 2022

(54) INTERNAL WALL END APPARATUS

(71) Applicant: STUDCO AUSTRALIA PTY LTD, Croydon South (AU)

(72) Inventors: Mark Simon McKechnie, Croydon South (AU); Warwick James McAlpin, Croydon South (AU); Benjamin Gordon Stevens, Croydon South (AU)

(21) Appl. No.: 17/499,003

(22) Filed: Oct. 12, 2021

(30) Foreign Application Priority Data
Oct. 13, 2020 (AU) 2020102698

(51) Int. Cl. E04F 13/06; E04C 2/04

(52) U.S. Cl. CPC E04F 13/06; E04C 2/043

(57) ABSTRACT

Apparatus (50) for fitting to an end of an internal wall, said apparatus (50) including a web portion (52) and a pair of legs (61, 63) extending from the web portion (52) in the same direction; at least one of the legs (61) in said pair of legs (61, 63) having a recess (56) that extends into a space formed by the web portion (52) and each of said legs (61, 63) such that a shadow line is created by the recess (56) near to the wall end in the overall finish of said wall.

### FIELD OF THE INVENTION

This invention relates to apparatus for application to the end of a wall and more particularly relates to apparatus that is affixed at the end of an internal wall for the purposes of providing an improved finish to each side of the wall.

### BACKGROUND OF THE INVENTION

Presently in order to complete a particular finishing aspect to the exposed end of a half wall inside a building, so as to cover the plaster boards and stud, it is necessary to go through a tedious and drawn out process. The desirable finish to such an internal wall is the creation of a vertical shadow line near to the outer edge of each wall plaster panel. The shadow line provides a slightly darker appearance to the wall compared to a wall not having such a shadow line. It gives the appearance of a more professional finish to the wall.

With reference to FIG. 1 the tedious and drawn out process typically, but not exclusively, involves the attachment of a first member 12, usually made of timber, to the web face 16 of stud 4 which is disposed between two parallel panels of plaster board 6 and 8. The following description is with respect to plaster board 6 but equally applies to plaster board 8 and any other form of a wall, which can be composite and made of a different material. An angle support member 10, which is generally made of metal and extends along the vertical edge of plaster board 6, is attached by screws 22 and 24 to the outer face of plaster board 6. The angle support member 10 is angled having a face 30, which is roughly perpendicular to the front face 28 and abuts against edge 31 of plaster board 6. A further face 32 is roughly perpendicular to face 30 and is therefore approximately parallel to the front face 28. The face 32 abuts against the outer edge 34 of the first member 12. A second member 14, also usually made of timber, is then secured through screws 40 to the first member 12.

The outer edge 36 of the second member 14 then creates, together with the face 32, outer edge 34 and face 30 of the support member 10 a recess in order to provide a shadow line to the overall finish of the finished wall.

This is a very cumbersome process which requires many components which are assembled in a particular order. It takes four products to form the desired finish and a lot of time to construct the entire end section. Several more fixings are required on the front face (second member 14) of the end section, that have to be countersunk and then backfilled to conceal the fixings. Furthermore two different trade skills are required, a carpenter to do the timber work of the first and second members, and a plasterer to do the wall framing and finishing sections. The installation is also out of sequence as the plasterer first installs the wall frame and plasterboard lining, then the carpenter completes the timber work, and finally the plasterer returns to install the finishing sections and plaster the walls. It is a time-consuming process and also adds to the cost of the overall finish of the wall to include a shadow line, due to excess labour and materials.

The present invention seeks to overcome one or more of the abovementioned disadvantages by providing an apparatus for fixing to the end of a wall in a simpler and less cumbersome manner.

### SUMMARY OF THE INVENTION

According to an aspect of the invention, there is provided apparatus for fitting to an end of an internal wall, said apparatus including:
a web portion; and
a pair of legs extending from the web portion in the same direction;
at least one of the legs in said pair of legs having a recess that extends into a space formed by the web portion and each of said legs such that a shadow line is created by the recess near to the wall end in the overall finish of said wall.

Preferably the wall includes a pair of plaster boards.

Preferably each leg in said pair of legs has a recess that extends into said space formed by the web portion and each of said legs such that a shadow line is created by each recess near to the wall end in the overall finish of said wall.

Preferably each leg has a connection member adapted for connection to a respective plaster board and to a stud. Preferably each connection member is located at the outer part of each leg adjacent a respective recess.

Each connection member may have a raised portion next to the respective recess to enable a finishing layer of plaster to be applied to each board. The respective recesses can either be aligned or non-aligned with one other.

The web portion may have a rebate for interacting with other connecting elements.

### BRIEF DESCRIPTION OF THE DRAWINGS

A preferred embodiment of the invention will hereinafter be described, by way of example only, with reference to the drawings in which:

FIG. 1 is a perspective view from above of a prior art method of finishing an internal end wall for providing a shadow line effect in the wall;

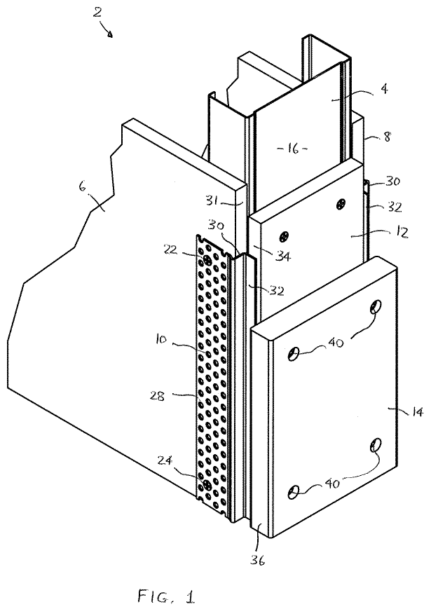

FIG. 2 is a perspective view from above of apparatus according to an embodiment of the present invention which is used as a one-piece fitting to the wall end;

FIG. 3 shows a perspective view from above of the apparatus of FIG. 2 as fitted to the components making up the end of the wall; and

FIG. 4 shows various end views of a different variety of profiles that can be used in accordance with the apparatus shown in FIG. 2.

### DETAILED DESCRIPTION OF THE PREFERRED EMBODIMENT

The following description is in relation to apparatus that fits to the end of an internal wall. The wall need not necessarily have a pair of boards, particularly made from plaster, but can be a composite wall made of other materials.

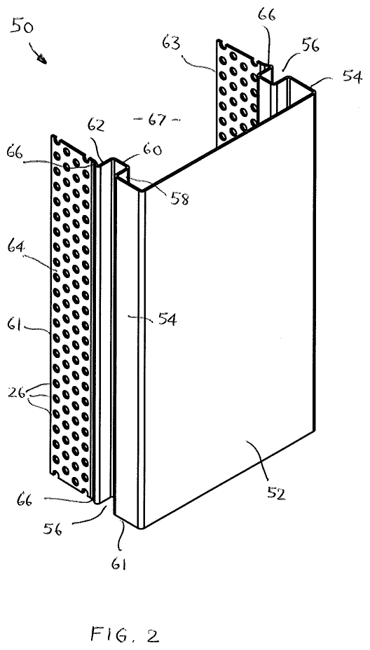

With reference to FIG. 2 there is shown apparatus 50, in the form of a one-piece capping to be attached to the end of an internal wall. The apparatus 50 is generally made from a suitable material, such as metal or plastic, and includes a web portion 52, a first leg 61 and a second leg 63 that extend in the same direction substantially perpendicular from the web 52. Each of the legs 61 and 63 generally have the same shape although mirror-imaged, in that there is a recess 56, for example in leg 61 formed throughout the whole length of the leg 61. The recess 56 can be formed in just one of the legs 61, 63. The recess 56, which protrudes into a space 67 formed by the web 52 and each of the legs 61 and 63, includes three faces 58, 60 and 62 with face 60 acting as a further web between the faces 58 and 62. This creates a space 65 which is not covered by plaster in the end stage of plastering so that it creates a visually appealing finish to the wall, on each side, by creating a shadow line along the whole length of the wall, adjacent or near to an outer edge of each side of the wall. The width of each of the faces 58, 60 and 62 can vary.

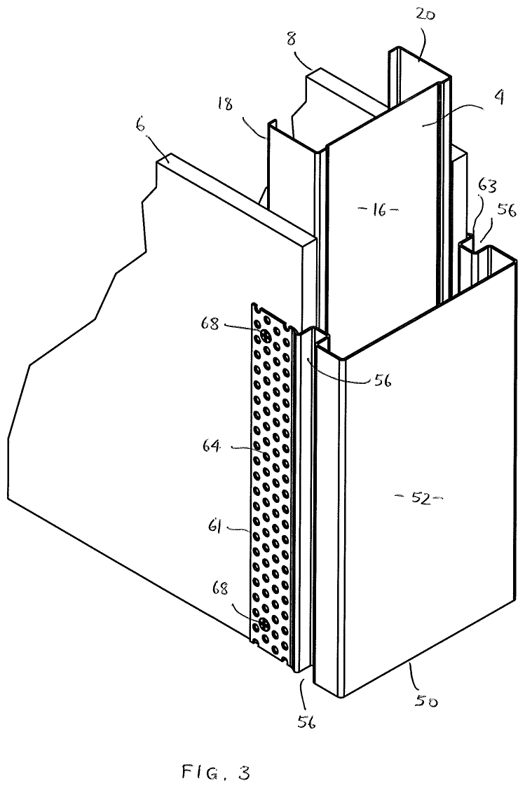

The outer part of each leg 61 and 63 includes a connection member 64 which may or may not have apertures 26 located therein. The apertures 26 are used to enable securing means 68 (FIG. 3), such as nails or screws, to attach the apparatus 50 to a respective plaster board 6, 8 on each side of the wall. Thus one connection member 64 would attach to one plaster board wall 6 and then the other connection member 64 would equally attach to the other parallel plaster board wall 8. There is also a raised portion 66, which can be a raised nib, step or curved portion, being a part of, and extending along the whole length of, the connection members 64, which adjoins the recess 56 at face 62. The reason why portion 66 is raised is to assist in the finishing of the plaster along the respective walls 6, 8. No plaster is attached to face 54 of the apparatus 50 in the finished product.

With regard to FIG. 3 there is shown the attachment of the apparatus 50 to plaster board panels 6 and 8 which form part of the end of a wall together with stud 4, having web portion 16, first leg 18 and second leg 20.

As is seen in FIG. 3 the apparatus 50 is fitted with the connection members 64 of legs 61 and 63 being attached respectively through screws 68 to the outer faces of plaster boards 6 and 8. The recess 56 remains along the whole length of the apparatus 50 from the top to the bottom of the wall (on each side) adjacent the end of the wall. As mentioned previously the inclusion of recess 56 on each face of the wall provides a visually appealing finish to the faces of the wall by providing the shadow line as a decorative feature of the wall.

The apparatus 50 can be made to a predetermined dimension offsite so that it is a simple matter for example a plasterer, just one trade, to construct the wall and attach the apparatus 50 to the end of the wall. The plasterer then finishes off the plastering by covering the connection members 64, leaving the recesses 56 and faces 54 free of plaster. Painting of the panels 6 and 8 can thereafter proceed to finish the wall. The web portion 52 can be colour matched or a different colour to the overall finished painted boards 6 and 8 of the wall.

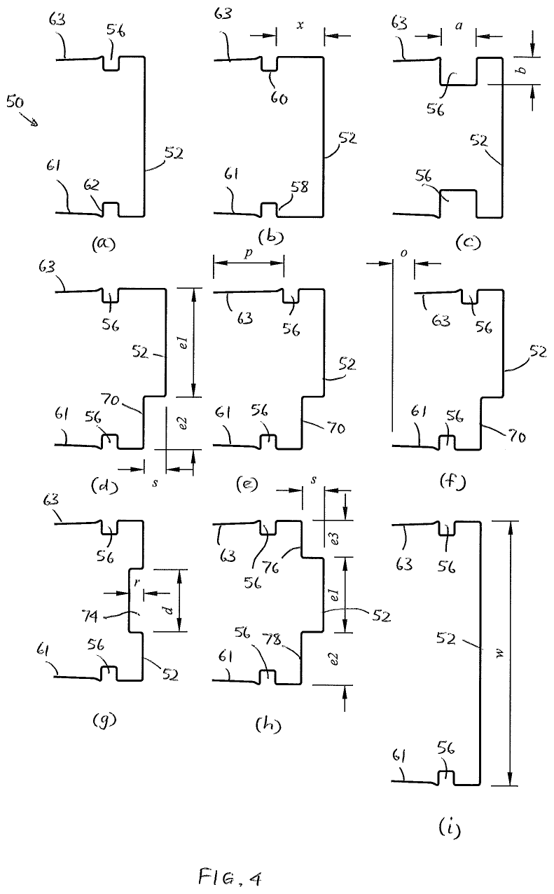

Referring to FIG. 4, a number of different profiles of the apparatus 50 are shown in the individual FIGS. 4(a) to 4(i). The length of the web portion 52 can vary, as seen in FIGS. 4(c) and 4(i). Generally the width of the web portion 52 can vary, but in most situations is about 100 mm. The width, depth and location of the recess 56 in each of the legs 61 and 63 can vary. For example in FIGS. 4(a) and 4(b) the recesses 56 are opposite one another on the legs 61, 63 while in FIGS. 4(e) and 4(f) the recesses 56 are offset or non-aligned with each other. The legs 61 and 63 can differ in width by dimension ‘o’ as seen in FIG. 4(f). The recesses 56 in FIG. 4(c), having dimensions ‘a’ and ‘b’ are wider than those in the other Figures.

A further modification is shown in FIGS. 4(d), 4(e) and 4(f) where the web portion 52 has a rebate 70 (with dimensions ‘s’ and ‘e2’) that can function as a door jamb. In FIG. 4(g) there is a trough or recess 74 (with dimensions ‘r’ and ‘d’) in the middle of web portion 52 that extends all the way along the web 52, and is used to house a sliding door in its closed position. However the recess 74 can interact with other connecting elements and is not limited to door elements. In FIG. 4(h) there is a central web portion 52 with a rebate 76 (with dimensions ‘s’ and ‘e3’) on one side and a further rebate 78 (with dimensions ‘s” and ‘e2’) on the other side of the central web portion 52. The rebates 76 and 78 can function to interact with other connecting elements such as a door jamb, but is not limited to doors.

The apparatus 50 of the present invention is made in one piece to finish the end of the internal wall and fitted and fixed quickly by one skilled tradesperson, a plasterer. There are no fixings on the outer face of the web portion 52 of the apparatus 50, so there is no need for concealment of the fixings. By having just one tradesperson, there is no sequence to follow between two tradespeople in constructing and finishing the end of the wall.

1. Apparatus for fitting to an end of an internal wall, said apparatus including:
a web portion; and
a pair of legs extending from the web portion, each leg in said pair of legs extending in the same direction;
at least one of the legs in said pair of legs having a recess that extends into a space formed by the web portion and each of said legs such that a shadow line is created by the recess near to the wall end in the overall finish of said wall.

2. Apparatus according to claim 1 wherein said wall includes a pair of plaster boards.

3. Apparatus according to claim 1 wherein each leg in said pair of legs has a recess that extends into said space formed by the web portion and each of said legs such that a shadow line is created by each recess near to the wall end in the overall finish of said wall.

4. Apparatus according to claim 3 wherein each leg has a connection member adapted for connection to a respective plaster board and to a stud.

5. Apparatus according to claim 4 wherein said connection member is located at an outer part of each leg adjacent a respective recess.

6. Apparatus according to claim 5 wherein said connection member has a raised portion next to the respective recess to enable a finishing layer of plaster to be applied to each board.

7. Apparatus according to claim 3 wherein the respective recesses are either aligned or non-aligned with one other.

8. Apparatus according to claim 1 wherein said web portion has a rebate for interacting with other connecting elements.
